(19) United States
(12) Patent Application Publication
(10) Pub. No.: US 2026/0131469 A1
(43) Pub. Date: May 14, 2026

(54) ARTIFICIAL INTELLIGENCE BASED BARTENDING SYSTEM

(71) Applicant: Techolution Consulting LLC, New York, NY (US)

(72) Inventor: Luv Tulsidas, New York, NY (US)

(73) Assignee: Techolution Consulting LLC, New York, NY (US)

(21) Appl. No.: 18/942,554

(22) Filed: Nov. 9, 2024

(51) Int. Cl. B25J 9/16; G06Q 30/0251; G06V 20/50

(52) U.S. Cl. CPC B25J 9/1679; G06Q 30/0271; G06V 20/50

(57) ABSTRACT

The present application provides an AI Bartending System that leverages artificial intelligence, machine learning, and advanced robotics to deliver an unparalleled bartending experience for users.

The AI Bartending System integrates a collaborative robot (cobot) and an AI Robotic Hand equipped with advanced sensors for precise and speedy drink preparation tailored to user preferences. In this system, users can interact with the system through an intuitive conversational AI concierge interface, requesting specific drinks or personalized recommendations. The system learns from user interactions and feedback using machine learning algorithms and experiential learning AI, continuously refining its recommendations and adapting to evolving user preferences.

Additionally, the system utilizes AI computer vision to perceive its environment, capturing both spatial and contextual information in real-time. This enables it to identify and localize key elements within its operational space, ensuring optimal performance. Furthermore, the system is capable of opening cans, twisting bottle caps, and mixing drinks with standard items and requires no special dispensers or pre-arranged setups.

Designed for scalability, the system efficiently handles multiple stations or queue-based ordering, ensuring smooth service even during peak hours.

### TECHNICAL FIELD OF THE INVENTION

The present application generally relates to bartending systems. Specifically, the present application relates to an Artificial Intelligence (AI) based bartending system that offers automated beverage services, leveraging artificial intelligence, machine learning, and advanced robotics to significantly enhance user interaction, streamline service efficiency, and ensure the highest quality in beverage preparation.

### BACKGROUND OF THE INVENTION

A bartending system is a comprehensive setup designed to streamline the preparation and serving of beverages in a bar setting. It integrates various components such as equipment, software, and robotic elements to enhance efficiency and consistency.

Traditional tools like shakers, mixers, and jiggers are used alongside modern automated devices that ensure precise measuring, mixing, and dispensing of drinks.

Conventional bartending methods and systems, whether manual or automated, encounter several challenges that hinder their ability to meet the expectations of modern consumers. Manual bartending systems rely on fixed menus and standardized recipes, which limit their flexibility in catering to individual preferences. This lack of customization often results in a generic experience for customers, as they receive drinks based on preset options rather than their specific tastes.

Moreover, manual systems are susceptible to human error, such as inaccurate measurements or inconsistent preparation techniques, leading to variations in drink quality that can impact customer satisfaction.

Existing automated bartending systems aim to improve efficiency through mechanization but face their own set of limitations. These systems typically operate within a predefined framework of recipes and operational procedures, which restricts their ability to adapt in real-time to changing customer demands or unforeseen circumstances. This dependency on predetermined settings means they cannot easily accommodate new drink requests or adjust recipes based on customer preferences.

Additionally, automated systems often require a fixed setup, which may not be easily scalable or adaptable to different bar environments, thereby limiting their operational flexibility.

Safety is a critical concern in both manual and automated bartending systems. Manual operations can pose risks due to human errors, while automated systems must ensure safe interactions with customers and employees.

Current technologies in automated bartending often lack robust safety features to detect and respond to human presence effectively, potentially increasing the risk of accidents or mishaps in busy bar environments. Addressing these safety concerns is essential to ensure the adoption and acceptance of automated bartending systems in commercial settings.

Scalability is another significant challenge faced by traditional and automated bartending systems alike, particularly during peak hours or high-volume periods. Manual bartending can struggle to keep up with demand due to limited manpower and operational capacity.

Similarly, automated systems may face bottlenecks in processing multiple orders simultaneously, especially if they are not designed to handle peak loads efficiently. This limitation can lead to delays in service and customer dissatisfaction, highlighting the need for scalable solutions that can maintain high standards of efficiency and quality under varying demand conditions.

Additionally, the absence of conversational AI concierge interfaces limits the interactive capabilities of these systems. Without intuitive interfaces that can engage users in natural language interactions and provide personalized recommendations, bartender systems struggle to enhance customer engagement and meet the high standards of service expected in today's hospitality industry.

To overcome these challenges and advance the state of the art, there is a pressing need for AI-powered systems that can analyze customer preferences in real-time, enabling personalized drink recommendations and dynamic recipe adjustments.

### SUMMARY OF THE INVENTION

The present invention is directed to an AI Bartending System that combines AI, machine learning, and advanced robotics to offer precise and customized drink preparation.

In an embodiment of the present invention, the system comprises a cobot, an AI robotic hand, and a conversational AI concierge interface. These components work together to ensure precision, speed, and personalized service, enhancing the overall user experience.

In a preferred embodiment of the present invention, the system includes an AI Robotic Hand capable of autonomously grasping and serving beverages of various shapes and sizes; a collaborative cobot assists with a plurality of tasks; a conversational AI concierge interface facilitates intuitive user interactions; a spatial perception and real-time decision-making mechanisms for optimizing object handling and path generation. The system's multi-functional handling mechanism integrates with existing bar infrastructure without requiring specialized equipment, supported by an operations management module that autonomously prioritizes beverage preparation tasks based on real-time user demands and inventory levels, monitored through AI-powered computer vision.

In another embodiment of the present invention, wherein the cobot further includes sensors for retrieving beverages with precision and speed, tailored to a user(s) preference.

In another embodiment of the present invention, the cobot includes safety algorithms to detect and respond to human presence, preventing accidents. These algorithms process the data from the proximity sensors and make real-time decisions to ensure human safety.

In yet another embodiment of the present invention, the system upon detection of the objects precisely localizes these objects within its 3D spatial framework, taking into account factors such as human safety, optimum path for approach, distance, orientation, and surrounding obstacles amongst others.

In yet another embodiment of the present invention, the system identifies plurality of objects within its operational space.

In yet another embodiment of the present invention, the system includes an AI computer vision system that employs stereoscopic cameras and machine learning models to accurately determine the position and orientation of objects in three-dimensional space.

It should be noted that while the present invention has been described with reference to fasteners, it is not limited to this particular type of manufactured object and can be adapted to inspect other types of objects as well. Additionally, various modifications and alterations to the system and method may be possible without departing from the scope of the invention.

### BRIEF DESCRIPTION OF THE DRAWINGS

The foregoing summary, as well as the following detailed description of various embodiments, is better understood when read in conjunction with the drawings provided herein. For the purposes of illustration, the drawings disclose subject matter which is not limited to the specific methods and instrumentalities disclosed. Further, the advantages and features of the present disclosure will better understood with reference to the following detailed description and claims taken in conjunction with the accompanying drawing, wherein like elements are identified with like symbols, and in which:

FIG. 1 illustrates a detailed schematic view of the AI bartending system in a table configuration; and

FIG. 2 illustrates a detailed schematic view of the AI bartending system in a track configuration.

### DETAILED DESCRIPTION OF THE INVENTION

The following description includes the preferred best mode of one embodiment of the present invention. It will be clear from this description of the invention that the invention is not limited to these illustrated embodiments but that the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,“ and the like or the respective closed phrases ”consisting of,“ ”consists of, the like.

As used herein, the singular forms “a,” “an,” and “the” designate both the singular and the plural, unless expressly stated to designate the singular only.

Further, the use of terms “first”, “second”, and “third”, and the like, herein do not denote any order, quantity, or importance, but rather are used to distinguish one element from another.

The term “computer program product” refers to software designed to optimize beverage service through AI, machine learning and computer vision technologies, enhancing operational efficiency and integrating with existing bar infrastructure.

The term “stereoscopic cameras” refers to cameras that work together to create a 3D image of the environment, helping the system understand depth and position of objects.

In the present invention, the beverages may be alcoholic and non-alcoholic drinks, juices, sodas, cocktails, and similar liquids intended for human consumption.

In the present invention, the objects may be bottles, cans, containers, cabinets amongst others.

The present invention relates to an AI Bartending System that integrates artificial intelligence (AI), machine learning (ML), and advanced robotics to revolutionize the beverage service industry

The AI Bartending System comprises several interconnected components that collectively enhances the efficiency, precision, and customer satisfaction in beverage preparation and service.

The automated robotic system is designed to autonomously interact with opening doors (cabinets and refrigerators), retrieving beverages and delivering them to users upon request. The system integrates a collaborative robot (cobot) with advanced computer vision capabilities and a cloud-based large language model (LLM) interface to process user commands. Through seamless coordination between cloud and edge components, the system executes complex tasks such as opening and closing of doors and retrieving specific items. This system is capable of performing precise mechanical tasks with minimal human intervention, offering a smooth, efficient, and interactive experience.

The AI bartending system operates under two configurations, one is table and other is track configuration.

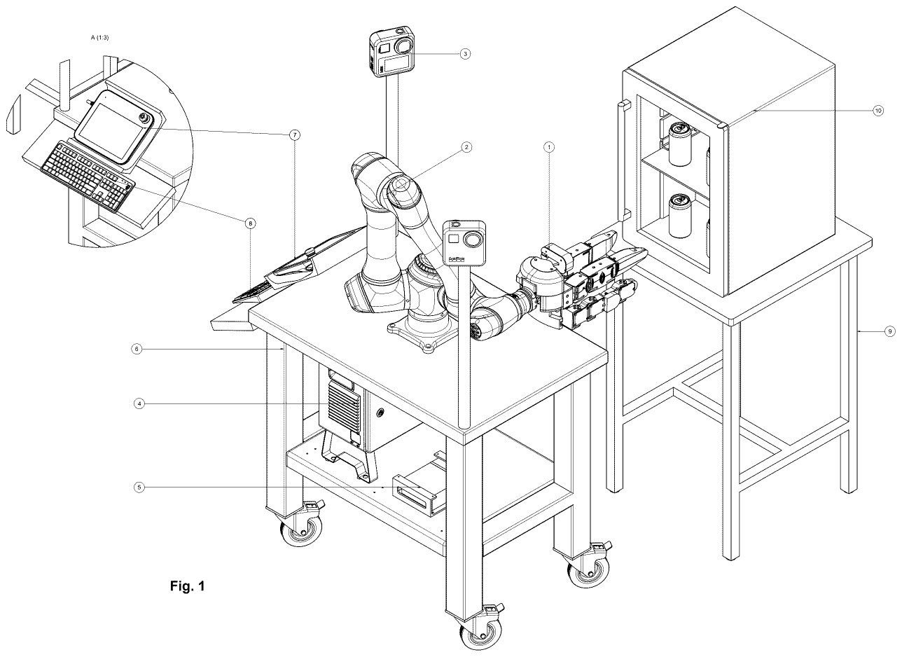

FIG. 1 refers to the detailed schematic view of the AI bartending system in a table configuration.

In this setup, the AI Hand 1 and Cobot 2 operate within a fixed workspace on the table 6. Their movements are restricted to the predefined area on the table 6, and they rely solely on their own joints and actuators for positioning and reaching tasks.

This configuration is simpler and suitable for tasks where the working area is relatively small, and precise linear movements are not as critical.

The table configuration includes the below components:

The AI Hand 1 is a sophisticated robotic end-effector designed for tasks that require precision, such as assembly, sorting, and manipulation of various objects. It operates primarily on the designated workspace, which is the table 6 and receives control signals from the controller 4. The controller communicates control signals to the AI Hand 1 to perform intricate actions with accuracy and efficiency.

Additionally, the AI Hand relies on visual feedback from the camera (spatial perception mechanism) 3 to adjust its movements dynamically, ensuring optimal performance in real-time. That is, the camera provides input regarding the identification and location of items within the AI Hand's reach. Based on this input, the AI Hand is controlled by the controller 4 to perform the tasks discussed here, such as to direct the hand to the object of interest, such as a bottle, grasp the bottle and/or the bottle cap, twist and remove the cap, pour content from the bottle to a glass, return the bottle to the initial location, etc.

The collaborative robot 2 works in close conjunction with the AI Hand 1 to enhance the overall system's functionality. The cobot 2 receives commands from the controller 4, allowing it to operate safely and efficiently within the shared workspace, maximizing the collaborative potential of the automated environment.

The camera 3captures high-resolution visual data of the entire workspace. This component is crucial for guiding the AI Hand 1 and Cobot 2 by providing real-time imaging and analysis. The camera 3 sends visual information to both the controller 4 and the mini PC 5 which processes the data to ensure accurate positioning and quality control with regard to performing the given tasks. By integrating this feedback loop, the system maintains precision in handling tasks and inspecting items on the table 6.

The controller 4 manages and synchronizes the operations of the AI Hand 1 and cobot 2. It processes inputs from the camera 3 to make real-time decisions and issue precise commands to the robotic components.

Additionally, the controller 4 interfaces with the PC 5 for high-level processing, which includes complex computations and adjustments made through the conversational AI concierge interface 7. This ensures a seamless flow of commands and responses within the system, optimizing the efficiency of the automated tasks.

The PC 5 functions as the core computing platform that runs critical software applications, including control interfaces, algorithmic processing, and data logging. PC 5 communicates directly with the controller 4 to monitor and adjust operational parameters based on real-time inputs, e.g., from the camera, feedback loop, sensors, etc.

Furthermore, user interaction is facilitated through interface 7 and keyboard 8 allowing operators to directly control the system, input commands, and adjust settings as needed, thus providing flexibility and oversight over the automated processes.

The table 6 is the primary workspace where the AI Hand 1 and cobot 2 perform their tasks. It is designed to provide a stable and accessible platform for all manipulations, featuring modular fixtures that can be adjusted to suit specific operations.

The system includes a cooler table 9 that allows for efficient handling of temperature-sensitive items, ensuring that workflows involving such materials are seamlessly integrated into the overall process. It is positioned adjacent to the table 6, it allows the AI Hand 1 to easily transfer items between the cooler environment and the workspace.

The conversational AI concierge interface 7 acts as the system's main control panel, offering a user-friendly display of the current status and allowing for direct interaction with the PC 5 and controller 4.

The keyboard 8 is an essential input device that provides operators with the means to enter data, execute programming commands, and adjust system settings manually. It is directly linked to the PC 5 and interface facilitating a smooth and efficient workflow.

The fridge 10 serves as the long-term storage solution for items that require refrigeration. It is linked to the AI Hand 1 and table allowing for easy retrieval and placement of temperature-controlled items as needed.

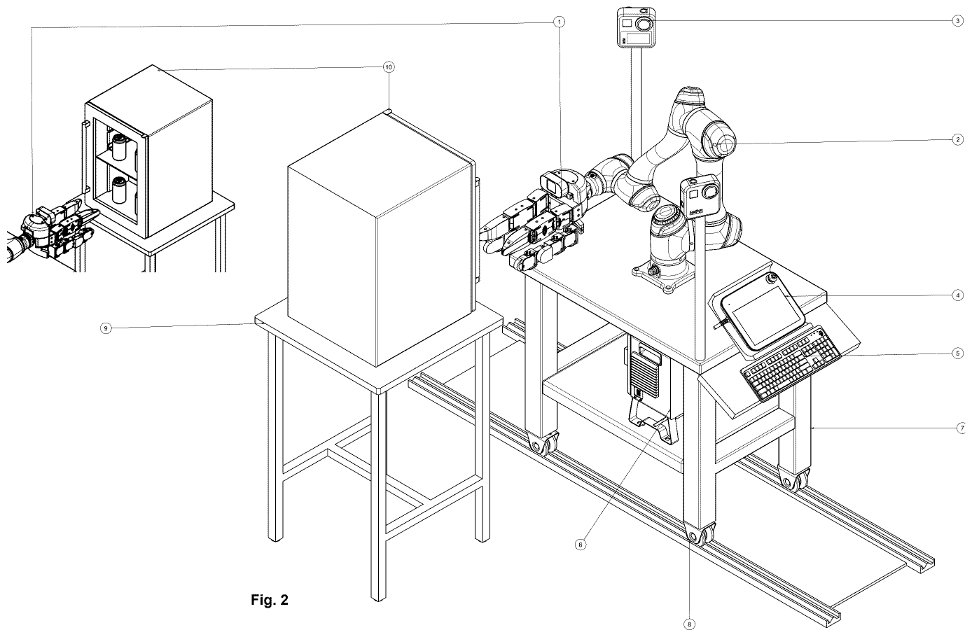

FIG. 2 refers to the detailed schematic view of the AI bartending system in a track configuration. All the components within this setup is similar to FIG. 1 expect for introduction of track.

The track configuration introduces a dynamic motion control system that significantly enhances the mobility of the AI Hand and Cobot.

In this setup, the AI Hand 1 and Cobot 2 are mounted on sliders that move along rails, allowing them to traverse predefined paths.

The track configuration 8 is particularly advantageous in environments where space is constrained or where specific movement patterns are necessary, such as navigating between different stations or reaching multiple points along a bar counter. The track's ability to be customized in length, shape, and configuration allows for precise and efficient task execution, making it suitable for complex operations that demand coordinated and flexible movements across a broader workspace.

The track configuration 8 offers the flexibility and precision needed for more complex, spatially distributed tasks.

Specifically, AI Robotic Hand 1 features advanced robotic arms. These arms provide the necessary agility and dexterity to perform intricate tasks such as grasping, lifting, and positioning beverage containers of various shapes, sizes, and surface textures.

The end effector 2 which is attached to the robotic arms includes several independently actuated fingers with tactile sensors for precise grip control. These sensors provide feedback that enable the robotic hand to adjust its grasp strength and orientation dynamically, ensuring secure handling of delicate glassware, rigid bottles and other beverage containers.

The second component is a cobot 2 that is integrated with the AI Robotic Hand 1 to operate alongside human bartenders safely and efficiently while assisting with a plurality of tasks. The cobot 2 employs proximity sensors for retrieving beverages with precision and speed, tailored to a user(s) preference in real time.

The cobot 2 can adjust its actions based on what the user wants. For example, if someone prefers their drink with extra ice, the robot can know this and make the drink exactly that way, right when it's needed.

The proximity sensors arranged in the cobot 2 are selected from a list including but not limited to ultrasonic sensors, infrared sensor, LIDAR sensors.

In the system the third component is a conversational AI concierge interface 7. The conversational AI concierge interface 7 serves as the primary interaction point between users and the AI Bartending System.

Using natural language processing (NLP) and machine learning algorithms, the AI concierge 7 interprets user requests, processes orders, and provides personalized drink recommendations based on individual preferences and historical interactions. In this regard, the system stores a unique ID with biometric data for, for example, face or voice recognition, of a user and historic interactions of that user along with the user's individual preferences. The system may then recognize the user and suggest drink recommendations based on the historic interactions and/or the individual's preferences. The system may learn or modify the recommendations based on new interactions with the system.

Within the interface 7, there exists a context-aware dialogue management that enables the system to use past interactions and user preferences to provide relevant responses and generate responses based on the current conversation context.

A key feature of the AI Bartending System is its spatial perception mechanism 3, enabled by advanced computer vision technology. Using this feature, stereoscopic cameras and depth-sensing algorithms provide the system with accurate, three-dimensional perception of its surroundings.

Through the autonomous real time decision-making ability mechanism the system is able to handle objects in a specific orientation further allowing it to learn from past experiences, improve its handling precision and optimal path generation.

The system calculates the most efficient route (optimum path) to take when moving around. It considers factors like the shortest distance, avoiding obstacles, and ensuring smooth movements. In this regard, the controller will issue commands to the AI hand, for example, to navigate a path that accounts for these factors. This helps it complete tasks quickly and efficiently, without unnecessary delays or errors.

One of the prominent features of the system is a multi-functional handling mechanism that integrates seamlessly with existing bar infrastructure for pouring drinks and serving users.

In addition to pouring drinks and serving users, the mechanism is able to autonomously open doors and cabinets to access stored beverages. This means the system can locate and retrieve various drinks from storage areas without human assistance.

The mechanism is also capable of retrieving ice from freezers. This involves opening the freezer, scooping the necessary amount of ice, and delivering it to the drink preparation area, ensuring drinks are properly chilled.

Furthermore, the system can prepare garnishes such as fruit slices or twists. It can handle the cutting and preparation of garnishes, adding the final touches to cocktails and other beverages.

These capabilities are achieved using pre-existing materials, ensuring compatibility with existing bar infrastructure and minimizing the need for custom modifications.

An operations management module oversees the logistical aspects of beverage preparation within the AI Bartending System. This module autonomously identifies, prioritizes, and schedules drink orders based on real-time customer requests, historical consumption patterns, and inventory levels.

Computer vision AI is employed to monitor stock levels and automatically trigger replenishment processes as needed, thereby optimizing inventory management and minimizing operational downtime.

Furthermore, the cobot 2 includes safety algorithms to detect and respond to human presence, preventing accidents. These algorithms process the data from the proximity sensors and make real-time decisions to ensure human safety.

The safety algorithms take the information from the proximity sensors and make quick decisions to prevent any accidents. For example, if the robot senses that a person is too close, it might slow down or stop moving to avoid bumping into them. This way, the robot can work alongside humans without causing any harm, ensuring that everyone stays safe.

The system identifies a plurality of objects within its operational space including but not limited to fridges, shelves amongst others. There is an AI computer vision system, which is a part of the present system, includes stereoscopic cameras and machine learning models to accurately determine the position and orientation of objects in three-dimensional space. More importantly, the system identifies the objects and accounts for those objects as it attempts the various tasks discussed herein. For example, the system may identify a refrigerator and ice chest as fixed components, and retain the location information of those components.

Within the system, machine learning and experiential learning AI play a pivotal role in the ongoing refinement and optimization of the AI Bartending System. By analyzing data from operational interactions, customer feedback, and environmental conditions, the system continuously improves its performance, adapts to new challenges, and enhances the overall user experience. This adaptive capability ensures that the system remains responsive to evolving customer preferences and industry trends, maintaining its competitive edge in the beverage service market.

A cloud-based infrastructure serves as the central hub for data storage, analysis, and decision-making within the AI Bartending System. This cloud platform supports scalable deployment, facilitates seamless integration with external systems and updates, and enables real-time synchronization of operational data across multiple locations.

The system has the ability to classify and differentiate between different beverage types and container sizes ensures accurate and efficient service delivery in high-demand environments.

The AI Bartending System incorporates a computer program product designed to optimize beverage service through advanced AI, machine learning (ML), and computer vision technologies.

This product comprises program instructions stored on a non-transitory computer-readable medium, enabling seamless integration with existing bar infrastructure and enhancing operational efficiency across multiple facets.

The program engages users through a sophisticated conversational AI concierge interface, facilitating intuitive interaction for beverage orders and personalized recommendations. This feature not only enhances customer satisfaction by providing tailored beverage options but also streamlines the ordering process, reducing wait times and improving service efficiency.

The system utilizes AI-driven computer vision technology to achieve precise object detection within a three-dimensional environment. Equipped with stereoscopic cameras and advanced depth perception algorithms, the AI accurately identifies and locates beverage containers, ingredients, and operational obstacles in real time.

This capability enables the robotic components to navigate and manipulate objects with precision, optimizing task execution and ensuring reliable service delivery in dynamic bar settings.

Machine learning algorithms play a pivotal role in refining beverage recommendations and system performance over time. By analyzing historical data, user preferences, and operational feedback, the system continuously learns and adapts its recommendations to align with evolving customer tastes and industry trends.

This adaptive capability not only enhances the quality of service but also maximizes operational efficiency by predicting demand patterns and optimizing inventory management.

Real-time decision-making instructions enable seamless integration with multiple operational stations within the bar infrastructure. These instructions facilitate dynamic response to changing conditions, allowing the system to adjust task priorities, allocate resources efficiently, and coordinate workflows across different service areas.

By leveraging standard items and components, the system minimizes implementation complexity and cost while ensuring compatibility with existing bar setups, thereby enhancing scalability and operational flexibility.

The computer program product embodies a synergistic blend of AI, machine learning and computer vision technologies, designed to elevate beverage service standards through enhanced automation, precision, and customer-centric interaction.

The system architecture is divided between cloud-based components and edge-based processing, ensuring seamless task execution, real-time interaction, and precise coordination. The cloud backend is responsible for handling user input, interpreting commands, and relaying instructions, while edge processing, managed by a local mini PC, governs the cobot's movements and controls object detection to enable smooth mechanical interactions.

The cloud infrastructure handles all user interactions and distributes tasks to the edge system for execution. A frontend and load balancer hosted on Google Cloud Run processes incoming requests, whether through voice or text, and forwards them to a backend service. At the core of the backend lies an LLM (large language model) running on a virtual machine (VM), which interprets natural language requests and translates them into actionable instructions.

Once the LLM processes the user input, it sends the appropriate commands to the mini PC via Google Pub/Sub, an asynchronous communication layer. This architecture minimizes latency while maintaining operational precision by ensuring real-time task allocation to the cobot for execution.

The mini PC serves as the local control hub, managing the cobot's mechanical operations and real-time object detection. The system operates in distinct modes, with each mode tailored to specific tasks to ensure smooth, accurate performance.

### Calibration Mode

In this mode, the cobot performs a 360-degree environmental scan using an object detection model and an Intel Realsense D405 depth camera. The scan identifies essential elements, such as the refrigerator, door handle, and beverages, and establishes positional offsets to align the cobot for future interactions. This information is stored in a database the preferably includes the location of these elements (including the dimensions of each element) for precise handling. These offsets compensate for slight variations in the environment, ensuring precise handling of objects during subsequent operations.

### Opening Door Mode

When a user requests a beverage, the system enters Opening Door Mode, following a predefined motion sequence to grasp the refrigerator handle and open the door. The sequence is preferably autonomously determined based on the data obtained during calibration. The cobot's movement planning relies on Doosan's inverse kinematics engine and custom trajectories to smoothly execute this task.

### Standby Mode

After the refrigerator door is open, the cobot transitions into Standby Mode, waiting for the next command. This mode ensures the system remains responsive to additional requests, such as specifying a particular beverage for retrieval.

Upon receiving a retrieval command, the object detection model identifies the requested beverage and, with the assistance of the depth camera, calculates the item's XYZ coordinates, preferably sufficient to construct a 3D representation of the beverage container. The cobot dynamically adjusts its position and grip based on these coordinates, ensuring accurate object interaction. This adaptive capability minimizes errors in grasping and placing items.

Once the beverage is successfully retrieved, the system delivers it to a designated handoff location, where the user can easily access it.

After completing the delivery, the system initiates Closing Door Mode. It executes a predefined movement sequence to close the refrigerator door securely, ensuring the fridge remains properly sealed. If no further commands are received, the cobot returns to Standby Mode, remaining ready for subsequent operations.

The object detection framework is based on a real-time object recognition model and the depth camera to achieve accurate spatial awareness. The object recognition model identifies key objects, such as the refrigerator, handle, and beverages, while the depth camera provides precise XYZ coordinate data to guide the cobot's positioning.

During Calibration Mode, the system sets positional offsets based on detected object locations. These offsets ensure that the cobot can maintain proper alignment throughout subsequent operations, even if minor changes occur in the environment. This capability enhances the system's consistency and precision when interacting with objects over multiple tasks.

The object detection framework relies on real-time object recognition model and the depth camera to achieve precise spatial awareness. The model identifies key objects, such as the refrigerator, handle, and beverages, while the depth camera provides additional XYZ coordinate data for accurate positioning. During the Calibration Phase, the system sets positional offsets based on detected object locations to ensure precise alignment throughout subsequent operations. These offsets compensate for any environmental changes or minor misalignments, enabling the system to interact consistently with the refrigerator and its contents.

The operational flow begins with Calibration Mode, where the system scans the environment and establishes reference points for accurate interaction. Once calibration is complete, the system is ready to receive user requests.

When a user issues a command, such as requesting a specific beverage, the input is processed by the LLM interface hosted in the cloud. The LLM interprets the command and sends the appropriate instructions to the mini PC through Google Pub/Sub. Upon receiving the task, the cobot uses the object detection model to locate the requested item and calculates its position using depth data. It then retrieves the item based on the identified coordinates and delivers it to the designated handoff point.

After the delivery is completed, the system triggers Closing Door Mode to close the refrigerator door. The cobot then returns to Standby Mode, ready to handle additional requests. This streamlined workflow ensures smooth, efficient task execution with minimal delays, providing a reliable and responsive experience for the user.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

1. An automated bartender system, comprising:
a. an AI Robotic Hand, wherein the hand consists of at least one robotic arm and at least one end effector attached to one end of a robotic arm;
wherein, the end effector includes plurality of fingers to autonomously grasp, hold and serve beverages of various shapes and sizes;
b. a collaborative cobot, wherein the cobot enhances operational safety by detecting humans and obstacles while assisting with a plurality of tasks;
wherein, the cobot further includes sensors for retrieving beverages with precision and speed, tailored to a user(s) preference;
c. a conversational AI concierge interface, wherein the interface facilitates user interaction, enabling beverage requests and personalized recommendations based on the users individual tastes and preferences;
d. a spatial perception mechanism, wherein the mechanism utilizes computer vision and human depth perception to detect object placement in three-dimensional spatial environments;
e. an autonomous real time decision-making ability mechanism, wherein the mechanism enables the system to handle objects in a specific orientation further allowing it to learn from past experiences, improve its handling precision and optimal path generation;
f. a multi-functional handling mechanism, wherein the mechanism integrates with existing bar infrastructure to autonomously perform tasks including opening doors (cabinets and refrigerators), handling objects, pouring beverages and preparing and garnishing beverages using pre-existing materials; and
g. an operations management module, wherein the module autonomously identifies and prioritizes beverage preparation tasks based on user preferences, current orders and monitors inventory level by computer vision AI.

2. The system of claim 1, wherein the beverages encompass a variety of liquid consumables including alcoholic and non-alcoholic drinks, juices, sodas, cocktails, and similar liquids intended for human consumption.

3. The system of claim 1, wherein the objects include but limited to bottles, cans, containers, cabinets amongst others.

4. The system of claim 1, wherein the robotic arm is configured to be moved in a manner similar to a human hand and can potentially be part of a larger robotic body.

5. The system of claim 1, wherein the sensors equipped in the cobot may be proximity sensors.

6. The system of claim 5, wherein the proximity sensors are selected from a list including but not limited to ultrasonic sensors, infrared sensor, and LIDAR sensors.

7. The system of claim 1, wherein the cobot further includes safety algorithms to detect and respond to human presence, preventing accidents.

8. The system of claim 7, wherein the safety algorithms process the data from the proximity sensors and make real-time decisions to ensure human safety.

9. The system of claim 7, wherein the safety algorithms process the data from the proximity sensors and make real-time decisions to ensure human safety.

10. The system of claim 1, wherein the pre-existing materials include at least one of fruits, herbs and garnishes.

11. The system of claim 1, wherein the conversational AI concierge interface employs context-aware dialogue management that enables the system to use past interactions and user preferences to provide relevant responses and generate responses based on the current conversation context.

12. The system of claim 1, wherein the system is configured to identify plurality of objects within its operational space including at least one of fridges and shelves.

13. The system of claim 1, wherein the system includes an AI computer vision system that employs stereoscopic cameras and machine learning models to accurately determine the position and orientation of objects in three-dimensional space.

14. The system of claim 1, wherein the system includes machine learning algorithms and experiential learning AI for continuously refining recommendations of the users based on interactions and feedback.

15. The system of claim 1, wherein there is a cloud server that serves as a hub of data storage, analysis, and decision-making based on past experiences and domain expert knowledge and encompassing physical/non-physical attributes derived from the surrounding environment.

16. The system of claim 1, wherein the fingers on the end effector of the AI hand are capable of adopting itself to accommodate objects of different sizes, shapes and surface types, mimicking the human hand.

17. The system of claim 1, wherein the system has the capability to dynamically adapt its grip strength, pressure values, positioning in response to inputs for handling both delicate objects and larger objects and accommodate their specific requirements.

18. The system of claim 1, wherein the system's computer vision capabilities include real-time object recognition and classification to distinguish between different types of drink containers and ingredients.

19. The system of claim 1, wherein the interface provides users with a means for interacting with the system using at least one of text, audio, video, and touch.

20. A computer program product comprising:
a. program instructions stored on a non-transitory computer-readable medium that, when executed, engage users via a conversational AI concierge interface for beverage orders and recommendation;
b. AI computer vision for precise object detection in 3D environment;
c. machine learning to refine beverage recommendations and system performance; and
d. real-time decision-making instructions to integrate with multiple operational stations and seamlessly integrates with existing bar infrastructure using standard items.
